(19) United States
(12) Patent Application Publication
(10) Pub. No.: US 2013/0189664 A1
(43) Pub. Date: Jul. 25, 2013

(54) METHOD AND APPARATUS FOR PROVIDING MEDIA STREAM SWITCHING BASED INTERACTIVE LECTURE SERVICE, AND RECEIVING METHOD AND APPARATUS

(71) Applicant: Electronics and Telecommunications Research Institute, Daejeon (KR)

(72) Inventors: Hyun Jin LEE, Daejeon-si (KR); Hwa Suk KIM, Daejeon-si (KR); Sang Kwon KIM, Daejeon-si (KR); Cho Rong YU, Daejeon-si (KR); Uk JANG, Seoul (KR); Dong Hun LEE, Daejeon-si (KR); Kee Seong CHO, Daejeon-si (KR)

(73) Assignee: Electronics and Telecommunications Research Institute, Daejeon (KR)

(21) Appl. No.: 13/692,674

(22) Filed: Dec. 3, 2012

(30) Foreign Application Priority Data
Jan. 19, 2012 (KR) 10-2012-0006360

(51) Int. Cl. G09B 19/00

(52) U.S. Cl. CPC G09B 19/00
USPC 434/308

(57) ABSTRACT

Disclosed herein are a method and an apparatus for controlling an interactive lecture service capable of performing questions and answers during a lecture without using a media mixer. A method for providing a media stream switching based interactive lecture service, includes: receiving a right to speak request from at least one student terminal by a lecturer terminal; assigning the right to speak to a specific student terminal in response to the right to speak request and receiving at least one of the question video and voice of the specific student terminal, by the lecturer terminal; and transmitting at least one of the receiving question video and voice of the specific student terminal to a terminal included in a lecture session by the lecturer terminal.

### CROSS-REFERENCE TO RELATED APPLICATIONS

This application claims the benefit of priority of Korean Patent Application No. 10-2012-0006360 filed on Jan. 19, 2012, all of which are incorporated by reference in their entirety herein.

### BACKGROUND OF THE INVENTION

1. Field of the invention

The present invention relates to a method for providing a lecture service and a system thereof, and more particularly, to a method and an apparatus for providing media stream switching based interactive lecture service and a receiving method and apparatus.

2. Related Art

With the rapid development of a broadband network, new types of service industries providing information using the Internet have started in many fields. In particular, with the distribution of an ultrahigh-speed communication network, video information can be transmitted in real time, which results in increasing expectation to create higher profits by providing video contents.

Among many video contents related fields, in particular, online education has been in the limelight as alternatives for solving a problem of private education expenses in an oversaturated private education market and providing equal opportunity learning. An online lecture using the Internet can solve restrictions of costs or time that is caused by the existing educational systems, such as typical university education, vocational education, seminar, organized education by professional education institutes, and the like.

That is, users of the online lecture can freely adjust course time and invest less costs and time for a lecture, while still obtain similar learning results which are generally provided by the existing education institutes. In addition, online lecture providers can develop online education sites and reduce initial costs uploading the sites on the Internet, such that they can provide various online lectures to users.

In the related art, a remote lecture on provided online is generally based on a lecturer centered unidirectional lecture. The existing online lecture usually simply sends to out previously recorded and edited lecture moving pictures to terminals of corresponding students, and the like. However, the unidirectional lecture can barely keep the students' interest and reduces the learning effect and the overall amount that a student hears of a lecture from beginning to end due to the absence of interaction between the student and the lecturer drastically reduces.

In order to solve the above problems, a video conference based interactive lecture service has been proposed, but a media mixer is necessarily used to provide a video conference based interactive lecture service.

### SUMMARY OF THE INVENTION

The present invention provides a method and an apparatus for providing an interactive lecture service capable of performing questions/answers during a lecture without using a media mixer.

In addition, the present invention provides a method and an apparatus for receiving an interactive lecture service capable of performing questions/answers during a lecture without using a media mixer.

In an aspect, a method for providing a media stream switching based interactive lecture service is provided. The method includes: receiving a right to speak request from at least one student terminal by a lecturer terminal; assigning the right to speak to a specific student terminal in response to the right to speak request and receiving at least one of question video and voice of the specific student terminal, by the lecturer terminal; and transmitting at least one of the receiving question video and voice of the specific student terminal to a terminal included in a lecture session by the lecturer terminal. The method for providing a media stream switching based interactive lecture service may further include: opening the lecture session and participating at least one student terminal in the lecture session, by the lecturer terminal. The method for providing a media stream switching based interactive lecture service may further include: retrieving the right to speak of the specific student terminal and transmitting at least one of the lecture video and voice of the lecturer terminal to the terminal included in the lecture session, by the lecturer terminal. The terminal included in the lecture session may include the lecturer terminal and at least one student terminal. The lecturer terminal may transmit at least one of the question video and voice to the terminal included in the lecture session via an IP transport network in a multicast scheme. The lecturer terminal may transmit at least one of the question video and voice to the terminal included in the lecture session in a unicast scheme. The lecturer terminal may transmit at least one of the lecture video and voice to the terminal included in the lecture session via an IP transport network in a multicast scheme. The lecturer terminal may transmit at least one of the lecture video and voice to the terminal included in the lecture session in a unicast scheme.

In another aspect, a method for receiving a media stream switching based interactive lecture service is provided. The method includes: transmitting a right to speak request to a lecturer terminal by a student terminal; assigning a right to speak to the student terminal from the lecturer terminal and transmitting at least one of a question video and voice of the student terminal to the lecturer terminal by the student terminal; and receiving at least one of the question video and voice from the lecturer terminal by the student terminal. The method for receiving a media stream switching based interactive lecture service may further include: when the lecturer terminal retrieves the right to speak of the student terminal, receiving at least one of lecture video and voice from the lecture terminal by the student terminal.

In still another aspect, an apparatus for providing a media stream switching based interactive lecture service is provided. The apparatus includes: a right to speak control unit that receives a right to speak request from at least one student terminal; a stream control unit that receives at least one of a question video and voice of the specific student terminal when the right to speak control unit assigns a right to speak to the specific student terminal in response to the right to speak request; and a stream processing unit that transmits at least one of question video and voice of the specific student terminal received by the stream control unit to a terminal included in a lecture session.

The apparatus for providing a media stream switching based interactive lecture service may further include: a session control unit that opens the lecture session and participates at least one student terminal in the lecture session. When the right to speak control unit retrieves the right to speak of the specific student terminal, the stream processing unit may transmit at least one of lecture video and voice of the lecturer terminal to the terminal included in the lecture session. The terminal included in the lecture session may include the apparatus for providing an interactive lecture service and at least one student terminal. The stream processing unit may transmit at least one of the question video and voice to the terminal included in the lecture session via an IP transport network in a multicast scheme. The stream processing unit may transmit at least one of the question video and voice to the terminal included in the lecture session in a unicast scheme. The stream processing unit may transmit at least one of the lecture video and voice to the terminal included in the lecture session via an IP transport network in a multicast scheme. The stream processing unit may transmit at least one of the lecture video and voice to the terminal included in the lecture session in a unicast scheme.

In still yet another aspect, an apparatus for receiving a media stream switching based interactive lecture service is provided. The apparatus includes: a right to speak requesting unit that transmits a right to speak request to a lecturer terminal; a transmitting unit that transmits at least one of a question video and voice to the lecturer terminal when the right to speak requesting unit is assigned with a right to speak from the lecturer terminal; and a receiving unit that receives at least one of the question video and voice from the lecturer terminal. When the lecturer terminal retrieves the right to speak of the right to speak requesting unit, the receiving unit may receive at least one of the lecture video and voice from the lecturer terminal.

### BRIEF DESCRIPTION OF THE DRAWINGS

FIG. 1 is a block diagram showing a configuration of a system for controlling a video conference based interactive lecture service according to the related art.

FIG. 2 is a data flow chart of a system for controlling a video conference based interactive lecture service according to the related art.

FIG. 3 is a block diagram showing a configuration of a system for controlling a media stream switching based interactive lecture service according to an exemplary embodiment of the present invention.

FIGS. 4A to 4D are conceptual diagrams of a method for controlling a media stream switching based interactive lecture service according to an exemplary embodiment of the present invention.

FIG. 5 is an interactive lecture service data flow chart in a case of using a multicast media streaming scheme according to an exemplary embodiment of the present invention.

FIG. 6 is an interactive lecture service data flow chart in a case of using a unicast media streaming scheme according to an exemplary embodiment of the present invention.

FIG. 7 is a flow chart of a method for providing an interactive lecture service according to an exemplary embodiment of the present invention.

FIG. 8 is a flow chart of a method for receiving an interactive lecture service to according to an exemplary embodiment of the present invention.

FIG. 9 is a block diagram showing a configuration of an apparatus for receiving an interactive lecture service according to an exemplary embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Further, in describing exemplary embodiments of the present invention, well-known functions or constructions will not be described in detail since they may unnecessarily obscure the understanding of the present invention.

Terms used in the specification, ‘first’, ‘second’, etc., may be used to describe various components, but the components are not to be construed as being limited to the terms. That is, the terms are used to distinguish one component from another component. Therefore, the first component may be referred to as the second component, and the second component may be referred to as the first component. The term ‘and/of’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that to when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In addition, components described in exemplary embodiments of the present invention are independently shown only in order to indicate that they perform different characteristic functions. Therefore, the components that are independently shown do not mean that each of the components may not be implemented by either hardware or software. That is, each of the components is divided for convenience of explanation, a plurality of components may be combined with each other to thereby be operated as one component or one component may be divided into a plurality components to thereby be operated as the plurality of components, which are included in the scope of the present invention as long as it departs from essential characteristics of the present invention.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In order to achieve the foregoing objects, a method for controlling a media stream switching based interactive lecture service according to an exemplary embodiment of the present invention may provide video/voice or moving picture of a lecturer from a lecturer terminal connected to a video/voice input device to students and select one of the students having a question and have the selected student ask a question. The method may provide the video/voice of the selected student to a lecturer and other students during a question.

Hereinafter, exemplary embodiments of the present invention will be described with reference to the accompanying drawings.

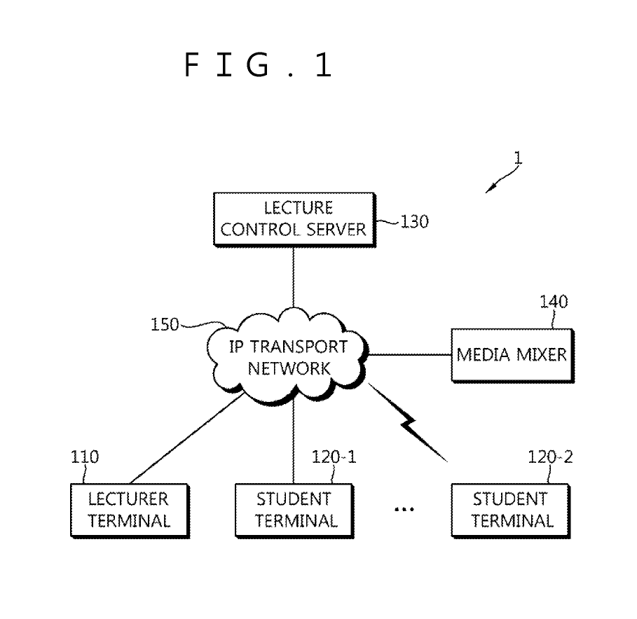

FIG. 1 is a block diagram showing a configuration of a system for controlling a video conference based interactive lecture service according to the related art. Referring to FIG. 1, a system 1 for providing a video conference based interactive lecture service may include a lecturer terminal 110, student terminals 120-1 and 120-2, a lecture control server 130, a media mixer 140, and an IP transport network 150.

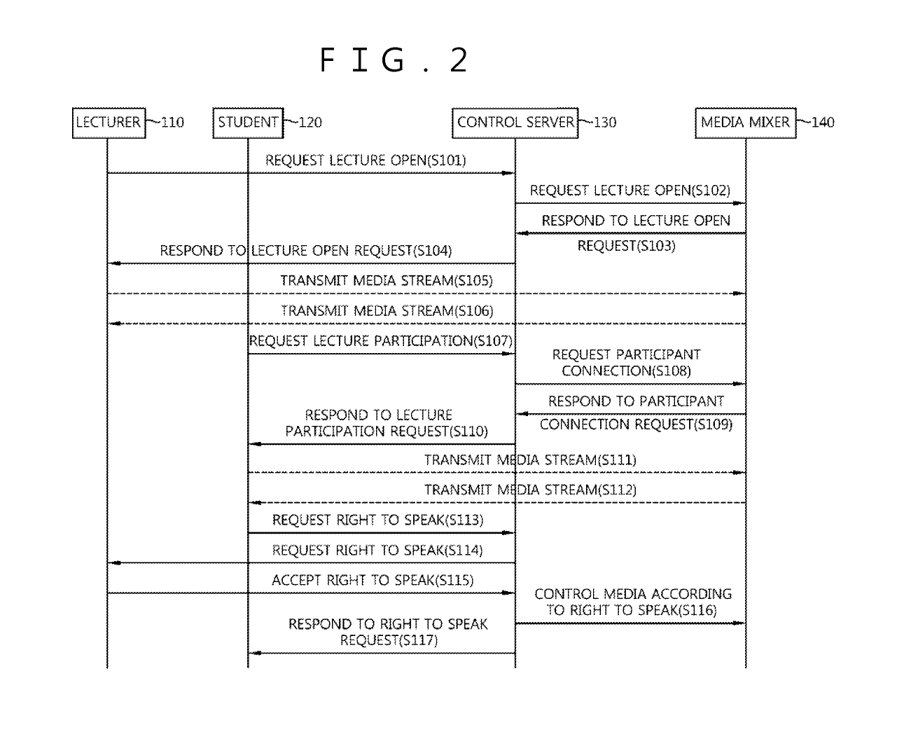

FIG. 2 is a data flow chart of a system for controlling a video conference based interactive lecture service according to the related art. The student terminal 120-1 and the student terminal 120-2 of FIG. 1 may be a student terminal 120 of FIG. 2.

Referring to FIG. 2, the lecturer terminal 110 requests a lecture open to the lecture control server 130 (S101). The lecture control server 130 makes one virtual room for a lecture and requests a lecture open to the media mixer 140 (S102). In this case, the number of participants participating in a lecture and layout information of video to be mixed are informed. The media mixer 140 is assigned with an IP address and a port number for receiving media streams from a lecturer and responds thereto (S103). The lecture control server 130 informs the lecturer terminal 110 of values received from the media mixer 140 and responds to a lecture open request (S104). The lecturer terminal 110 streams the video/voice of the lecturer to the media mixer 140 (S105). The media mixer 140 mixes videos according to the defined layout and streams the mixed videos to the lecturer terminal 110 (S106).

When the student terminal 120 requests lecture participation to the lecture control server 130 (S107), the lecturer control server 130 requests participant connection to the media mixer 140 (S108). The media mixer 140 is assigned with an IP address and a port number for receiving media streams from students and responds thereto (S109). The lecture control server 130 informs the student terminal 120 of values obtained from the media mixer 140 (S110). The student terminal 120 streams the video/voice of the student to the media mixer 140 (S111). The media mixer 140 streams the mixed video to the student terminal 120 (S112). In this case, the media streams streamed to the lecture are changed to streams in which the videos/voices of participating students are mixed and then, are streamed. In this case, there may be two types of voice streaming methods. One method mixes voices of all the participants participating in a lecture and streams the mixed voices and the other method streams only the voice of a lecturer or a student having a right to speak.

When the student terminal 120 requests a right to speak to the lecture control server 130 (S113), the lecturer control server 130 transmits the request to the lecturer terminal 110 (S114). When the lecturer terminal 110 accepts the right to speak of the participating terminal (S115), the lecture control server 130 performs a control to change a layout of a screen or a voice streaming method to the media mixer 140 (S116). Simultaneously, the lecturer control server 130 transmits a response to the request of a right to speak to the student terminal 120 (S117).

However, in order to provide the video conference based interactive lecture service, there is a disadvantage in that the media mixer is necessarily used. Therefore, in the exemplary embodiment of the present invention, a method for providing a control to stream videos or voices of a terminal having a right to speak by switching the media streams in the lecturer terminal to provide an interactive lecture service without a media mixer is provided.

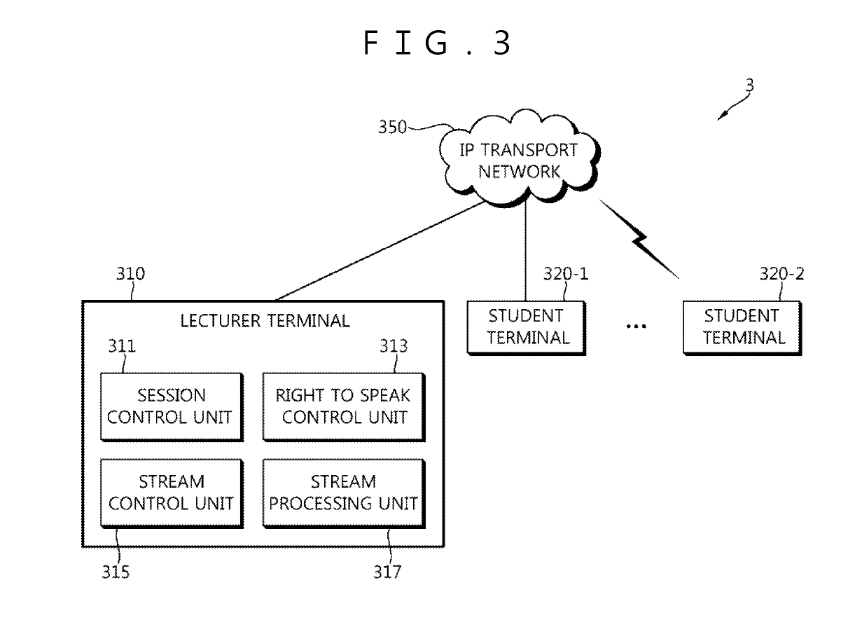

FIG. 3 is a block diagram showing a configuration of a system for controlling a media stream switching based interactive lecture service according to an exemplary embodiment of the present invention.

Referring to FIG. 3, a system 3 for providing a media stream switching based interactive lecture service may include a lecturer terminal 310, student terminals 320-1 and 320-2, and an IP transport network 350. The lecturer terminal 310 may include a session control unit 311 that controls sessions of lecturers and students, a right to speak control unit 313 that assigns a right to speak to a specific student among students requesting a right to speak and retrieves the right to speak again, a stream control unit 315 that controls media streaming according to the right to speak, and a stream processing unit 317 that switches media streams according to a request of the stream control unit 315. The student terminals 320-1 and 320-2 access the IP transport network 350 through a wired and wireless communication unit. Here, the student terminals 320-1 and 320-2 may be a smart phone, a smart pad, a PC, and the like.

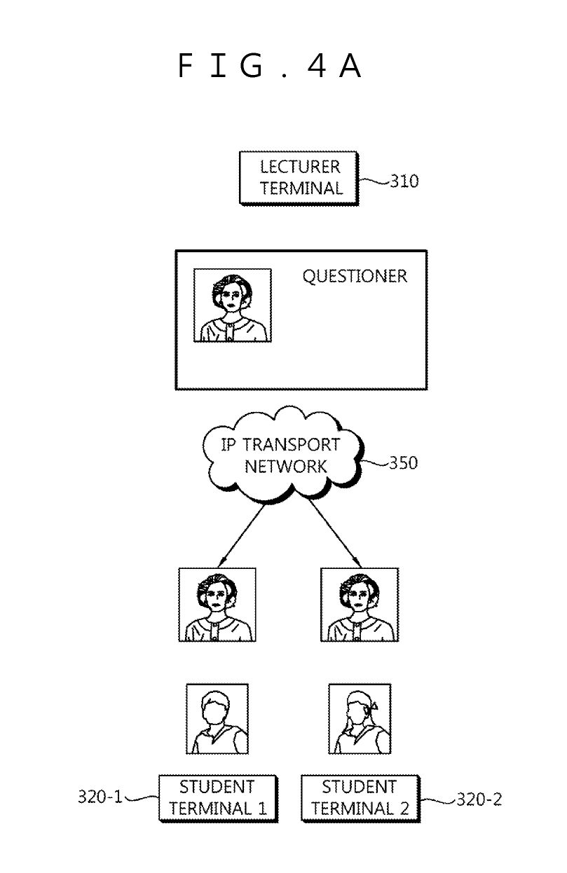

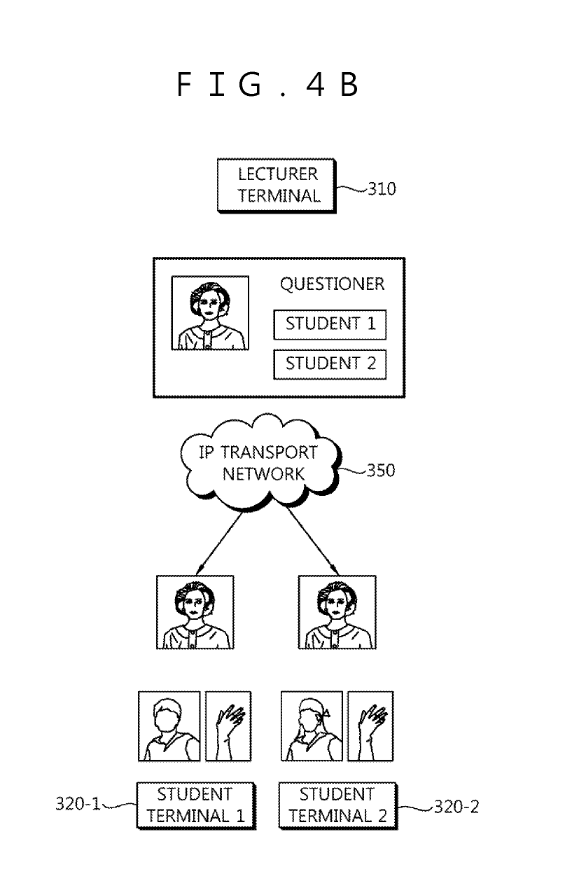

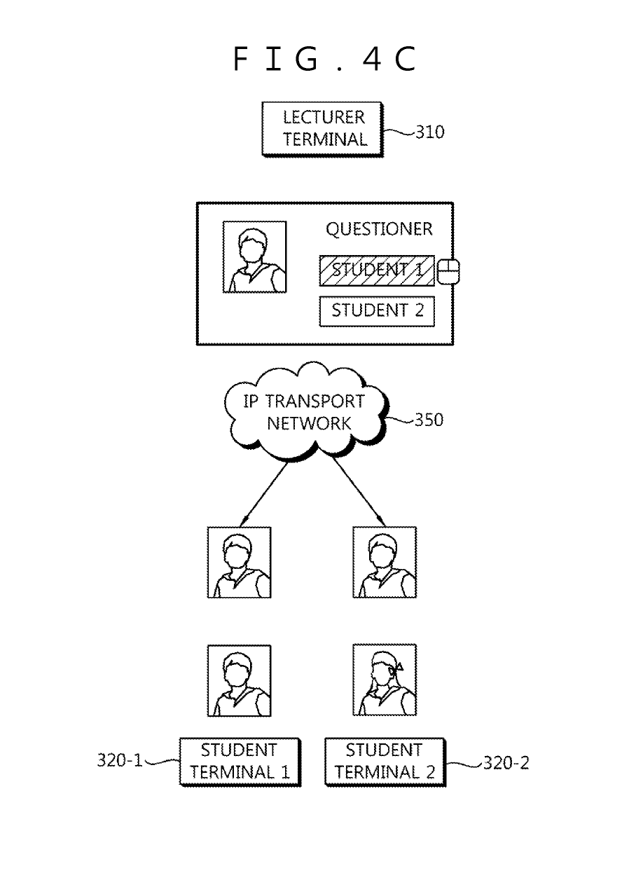

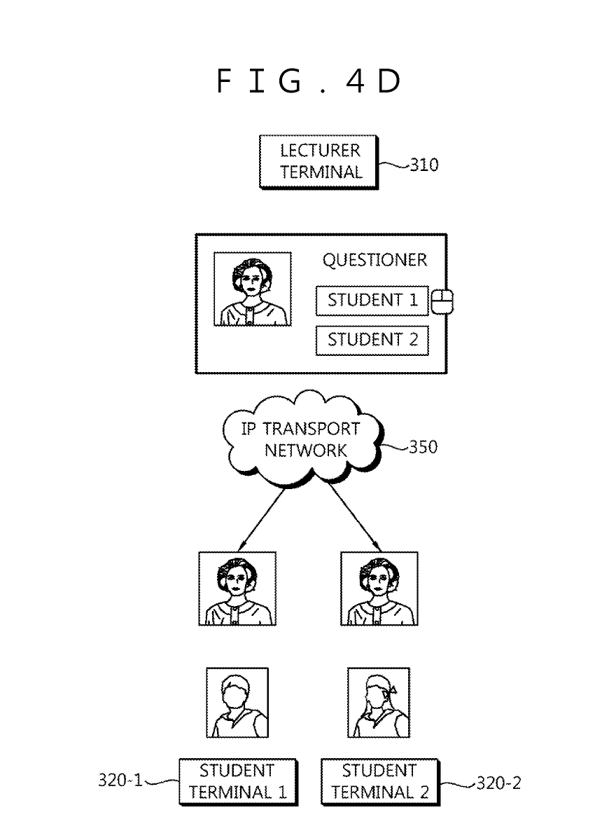

FIGS. 4A to 4D are conceptual diagrams of a method for controlling a media stream switching based interactive lecture service according to an exemplary embodiment of the present invention.

Referring to FIG. 4A, when a lecture is opened in the lecturer terminal 310 and the student terminals 320-1 and 320-2 participate in a lecturer through the IP transport network 350, the lecture participants receive video/voice of a lecturer. That is, the video/voice is transmitted to both of the lecturer terminal 310 and the student terminals 320-1 and 320-2 from the lecturer terminal 310.

Referring to FIG. 4B, when the student terminals 320-1 and 320-2 request a right to speak, a questioner list is popped-up to the lecturer terminal 310. For example, when the student terminal 1 320-1 requests a right to speak, “student 1” is displayed in the lecturer terminal 310 by being added to the questioner list. In addition, when the student terminal 2 320-2 requests a right to speak, “student 2” is displayed in the lecturer terminal 310 by being added to the questioner list. FIG. 4B shows a type in which both of the student terminal 1 320-1 and the student terminal 2 320-2 request the right to speak and the “student 1” and the “student 2” are displayed in the lecturer terminal 310 on the questioner list.

Referring to 4C, when the lecturer terminal 310 assigns a right to speak to a specific student among students included in the questioner list, the video/voice of the student to which the right to speak is assigned is streamed to the lecture participant. For example, as shown in FIG. 4C, when the “student 1” and the “student 2” are included in the questioner list, the video/voice from the student terminal 1 320-1 are transmitted to both of the lecturer terminal 310 and the student terminals 320-1 and 320-2 when the lecturer terminal 310 selects the “student 1” and assigns a right to speak thereto.

Referring to FIG. 4D, when the lecturer terminal 310 retrieves the right to speak from the student again, the video/voice of the lecturer is streamed again. That is, as shown in FIG. 4D, when the lecturer terminal 310 retrieves the right to speak assigned to the “student 1” again, the video/voice from the lecturer terminal 310 are transmitted to all of the lecturer terminal 310 and the student terminals 320-1 and 320-2.

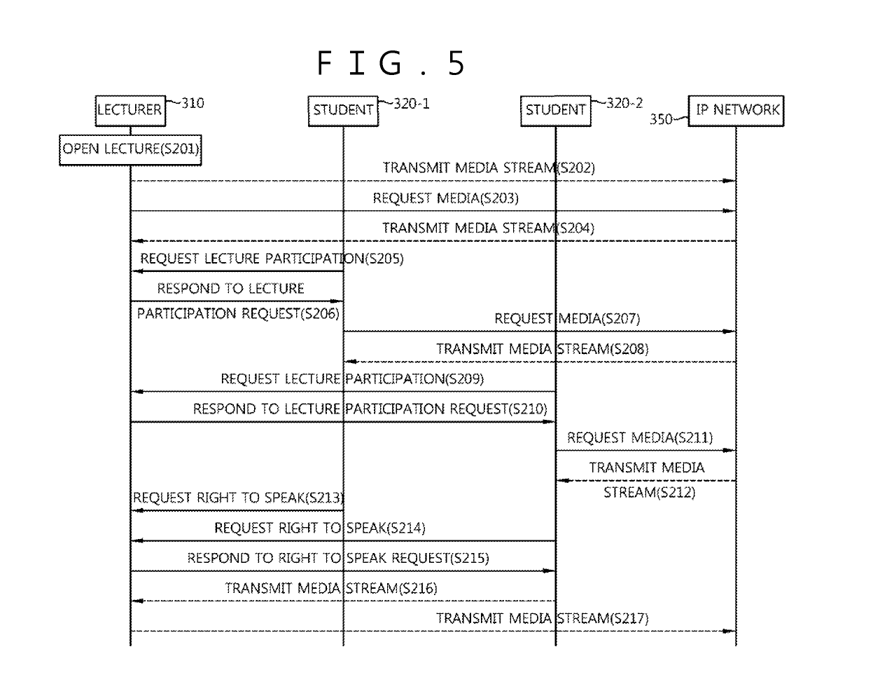

FIG. 5 is an interactive lecture service data flow chart in a case of using a multicast media streaming scheme according to an exemplary embodiment of the present invention.

As shown in FIG. 5, the lecturer terminal 310 opens a lecture in the interactive lecture service of the multicast media streaming scheme and assigns the multicast IP and port (S201) and streams the video/voice or the moving picture of the lecturer in the multicast (S202). That is, the lecturer terminal 310 serves as a multicast source. Simultaneously, the lecturer terminal 310 joins in a multicast group to request the media (S203) and receives the multicast media stream (S204). The received multicast stream is discarded. The lecturer terminal reproduces the video/voice or the moving picture of the lecturer.

When the student terminal 320-1 requests lecture participation to the lecturer terminal 310 (S205), the lecturer terminal 310 informs the multicast IP and port in response to the lecture participation request (S206). The student terminal 320-1 joins in a multicast group to request the media (S207) and receives the multicast media stream (S208).

Further, when the student terminal 320-2 requests the lecture participation to the lecturer terminal 310 (S209), the lecturer terminal 310 informs the multicast IP and port in response to the lecture participation request (S210). The student terminal 320-2 joins in a multicast group to request the media (S211) and receives the multicast media stream (S212).

When the student terminal 320-1 requests a right to speak and the student terminal 320-2 requests a right to speak, a list of students requesting the right to speak is transmitted to the lecturer terminal 310 and when the lecturer terminal 310 selects the specific student among the students included in the list and assigns the right to speak to the selected student (S215), the student terminal 320-2 to which the right to speak is assigned streams the video/voice of the student to the lecturer terminal 310 (S216). The lecturer terminal 310 streams the video/voice of the student received from the student terminal 320-2 having the right to speak in the multicast, instead of the video/voice stream of the lecturer (S217).

The student terminal 320-2 to which the right to speak is assigned discards the received multicast stream and reproduces the video/voice of the student, similar to the lecturer terminal 310 when the video/voice of the lecturer are streamed.

As described above, the lecturer terminal 310 switches the media stream that becomes the multicast source according to the right to speak to optionally stream the video/voice of the lecturer terminal 310, the student terminal 320-1, or the student terminal 320-2, thereby providing an interactive lecture service of a push to talk type.

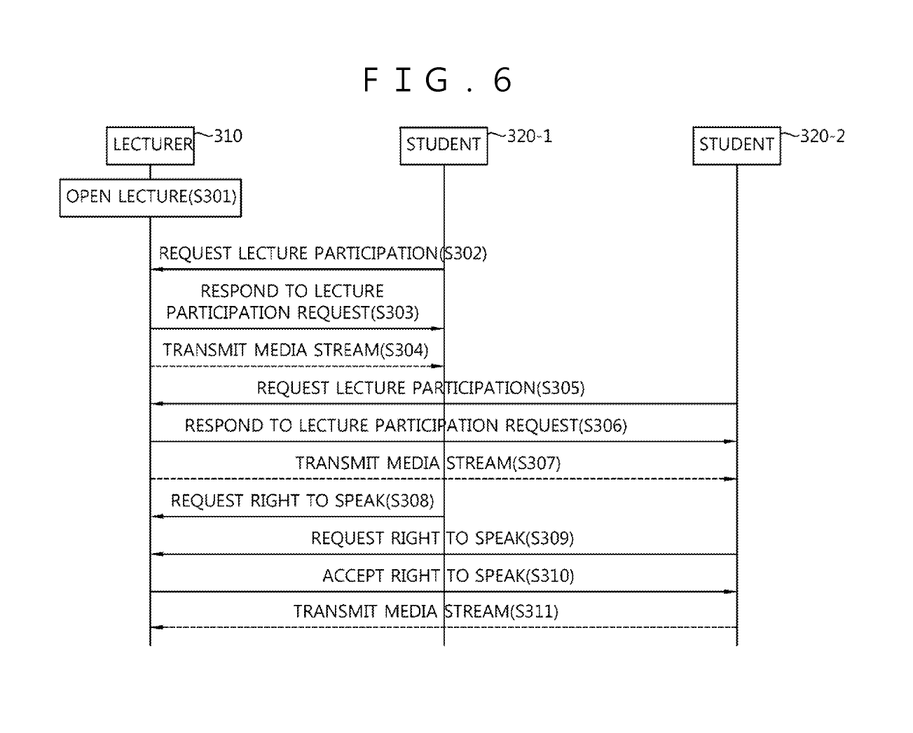

FIG. 6 is an interactive lecture service data flow chart in a case of using a unicast media streaming scheme according to an exemplary embodiment of the present invention.

As shown in FIG. 6, the lecturer terminal 310 opens a lecture in an interactive lecture service of a unicast media streaming scheme (S301) and the lecturer terminal reproduces the video/voice or the moving picture of the lecturer. When the student terminal 320-1 requests the lecture participation to the lecturer terminal 310 (S302), the lecturer terminal 310 transmits a response to the lecture participation request to the student terminal 320-1 (S303) and transmits the media stream (S304).

In addition, when the student terminal 320-2 requests the lecture participation to the lecturer terminal 310 (S305), the lecturer terminal 310 transmits a response to the lecture participation request to the student terminal 320-2 (S306) and transmits the media stream (S307).

When the student terminal 320-1 requests the right to speak (S308) and the student terminal 320-2 requests the right to speak (S309), the lecturer terminal 310 assigns the right to speak to the specific student terminal among the student terminals requesting the right to speak. As shown in FIG. 6, the lecturer terminal 310 may accept the right to speak to the student terminal 320-2 (S310). The student terminal 320-2 to which the right to speak is assigned streams the video/voice of the student of the student terminal 320-2 to the lecturer terminal (S311). The lecturer terminal 310 streams the video/voice of the student received from the student terminal 320-2 having the right to speak, instead of the video/voice stream of the lecturer. The student terminal 320-2 to which the right to speak is assigned discards the media stream transmitted from the lecturer terminal 310 and reproduces the video/voice of the student.

The right to speak may be provided in several ways. The video of the lecturer or the student having the right to speak may be shown larger than the videos of other participants and the videos can be left as they are and only the voice of the speaker can be streamed.

Method for Providing Media Stream Switching Based Interactive Lecture Service

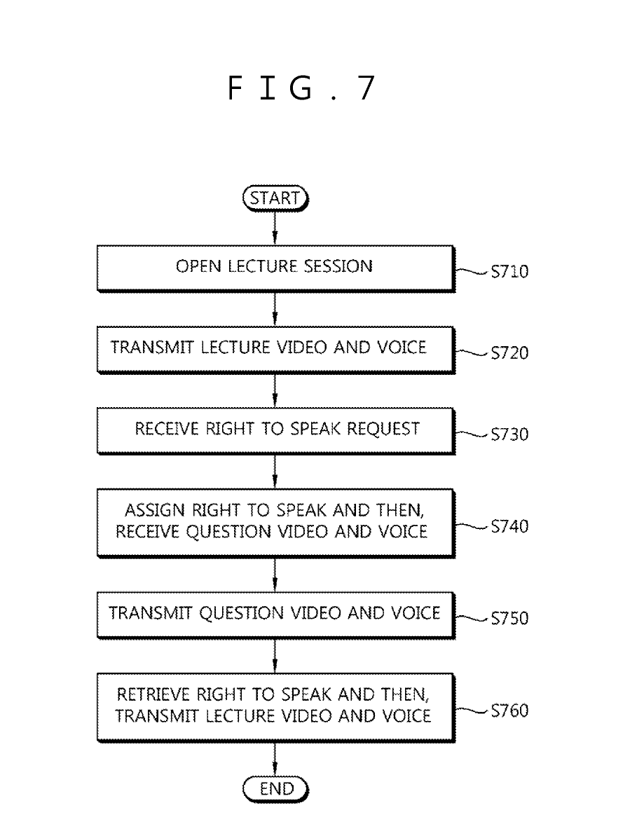

FIG. 7 is a flow chart of a method for providing an interactive lecture service according to an exemplary embodiment of the present invention.

Referring to FIG. 7, according to the method for providing an interactive lecture service according to an exemplary embodiment of the present invention, the lecturer terminal first opens the lecture session and at least one student terminal participates in the lecture session (S710).

The lecturer terminal transmits at least one of lecture video and voice to the terminal included in the lecture session (S720). Referring again to FIG. 4A, the lecture video and voice of the lecturer may be transmitted to the lecturer terminal and the student terminals.

Hereinafter, the lecturer terminal receives a request for right to speak from at least one student terminal (S730). Referring to FIG. 4B, the request for right to speak may be received from the plurality of student terminals and the received request for right to speak is displayed in the lecturer terminal. The lecturer terminal may respond to request for right to speak of the specific student terminal among the student terminals requesting the right to speak.

The lecturer terminal assigns the right to speak to the specific student terminal in response to the request for right to speak and receives at least one of question video and voice of the specific student terminal (S740).

Hereinafter, the lecturer terminal transmits at least one of the received question video and voice of the specific student terminal to the terminal included in the lecture session (S750). That is, as shown in FIG. 4C, while the lecturer terminal assigns the right to speak to the specific student terminal, at least one of the question video and voice of the student terminal having the right to speak may be transmitted to the lecturer terminal, the student terminal having the right to speak, and the student terminals having no right to speak.

After predetermined time lapses, the lecturer terminal retrieves the right to speak of the specific student terminal, and at least one of the lecture video and voice of the lecturer terminal may be transmitted to the terminal included in the lecture session (S760). When the question of the student terminal ends, the lecturer terminal may respond to the question or progress the stopped lecture. As shown in FIG. 4D, the right to speak of the student terminal is retrieved and at least one of the lecture video and voice of the lecturer terminal may be transmitted to the terminals included in the lecture session including the lecturer terminal and the student terminal.

Here, the terminal included in the lecture session may include the lecturer terminal and at least one student terminal. Both of the student terminals having the right to speak and the student terminals having no right to speak, which are terminals included in the lecture session, may receive and transmit at least one of the lecture video and voice of the lecturer terminal or at least one of the question video and voice of the student terminal

Here, when the lecturer terminal transmits at least one of the video and voice of the lecturer terminal or at least one of the question video and voice of the student terminal to the terminals included in the lecture session, the video and voice may be transmitted in a broadcast scheme or a unicast scheme using the IP transport network.

That is, in the case of using the broadcasting scheme, when the lecturer terminal opens the lecture session, the lecturer terminal informs the student terminals wanting to participate in the lecture session of the multicast IP and port of the lecture session and the student terminal may receive at least one of the lecture video and voice or at least one of the question video and voice via the IP transport network based on the IP and port.

When using the unicast scheme, at least one of the video and voice is directly transmitted between the lecturer terminal and the student terminal without passing through the IP transport network.

Method for Receiving Media Stream Switching Based Interactive Lecture Service

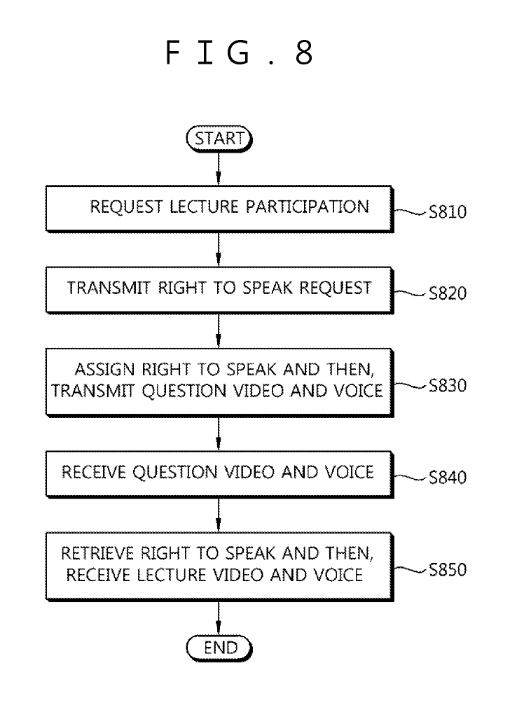

FIG. 8 is a flow chart of a method for receiving an interactive lecture service according to an exemplary embodiment of the present invention. A method for allowing a student terminal to receive an interactive lecture service in correspondence to the foregoing method for providing an interactive lecture service, is disclosed. The student terminal transmits the lecture participation request to the lecture session opened by the lecturer terminal (S810) and is approved by the lecturer terminal and thus, is included in the lecture session.

As shown in FIG. 8, the student terminal first transmits the right to speak request to the lecturer terminal (S820). As shown in FIG. 4B, the student terminals requesting the right to speak to is displayed in the lecturer terminal, and the lecturer terminal may select the specific student terminal.

When the lecturer terminal selects the student terminal, the student terminal is assigned with the right to speak from the lecturer terminal and transmits at least one of the question video and voice of the student terminal to the lecturer terminal (S830).

The student terminal receives at least one of the question video and voice from the lecturer terminal (S840). The lecturer terminal transmits at least one of the question video and voice to the terminal included in the lecture session and the student terminal receives at least one of the received question video and voice and thus, may discard the received video and voice without performing separate processing.

Hereinafter, when the question is completed and the lecturer terminal retrieves the right to speak of the student terminal, the student terminal receives at least one of the lecture video and voice from the lecturer terminal (S850) and thus, can obtain a response to a question or continue to take the stopped lecture.

Here, when the student terminal receives at least one of the video and voice or at least one of the question video and voice of the student terminal from the lecturer terminal, the video and voice may be transmitted in the broadcast scheme or the unicast scheme using the IP transport network.

That is, in the case of using the broadcasting scheme, the student terminal receives the multicast IP and port information of the lecture session when the lecturer terminal opens the lecture session and informs the student terminal of the receive information and the student terminals may receive at least one of the lecture video and voice or at least one of the question video and voice via the IP transport network based on the IP and port.

When using the unicast scheme, at least one of the video and voice is directly transmitted between the lecturer terminal and the student terminal without passing through the IP transport network.

Apparatus For Providing Media Stream Switching Based Interactive Lecture Service

As shown in FIG. 3, an apparatus 310 (lecturer terminal) for providing a media stream switching based interactive lecture service may include a session control unit 311 that opens the lecture session and participates at least one student terminal 320 in the lecture session, a right to speak control unit 313 that receives the right to speak request from at least one student terminal 320, a stream control unit 315 that receives at least one of the question video and voice of the specific student terminal at the time of assigning the right to speak to the specific student terminal by the right to speak control unit 313 in response to the right to speak request, and a stream processing unit 317 that transmits at least one of the question video and voice of the specific student terminal received by the stream control unit 315 to the terminal included in the lecture session.

When the right to speak control unit 313 retrieves the right to speak of the specific student terminal, the stream processing unit 317 may transmit at least of the lecture video and voice of the lecturer terminal 310 to the terminal included in the lecture session.

Here, the terminal included in the lecture session may include the apparatus 310 for providing an interactive lecture service and at least one student terminal 320 and may include the student terminal having a right to speak and the student terminal having no a right to speak.

Here, when the stream processing unit 317 transmits at least one of the lecture video and voice or at least one of the question video and voice of the student terminal to the terminals included in the lecture session, the video and voice may be transmitted in the broadcast scheme or the unicast scheme using the IP transport network.

That is, in the case of using the broadcasting scheme, when the session control unit 311 opens the lecture session, the session control unit informs the student terminals 320 wanting to participate in the lecture session of the multicast IP and port of the lecture session and the student terminals 320 may receive at least one of the lecture video and voice or at least one of the question video and voice via the IP transport network based on the IP and port.

When using the unicast scheme, at least one of the video and voice may be directly transmitted between the stream processing unit 317 and the student terminal 320 without passing through the IP transport network.

Apparatus for Receiving Media Stream Switching Based Interactive Lecture Service

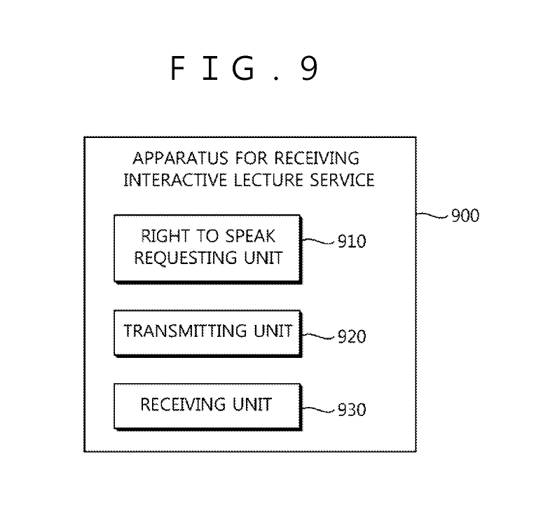

FIG. 9 is a block diagram showing a configuration of an apparatus for receiving an interactive lecture service according to an exemplary embodiment of the present invention. An apparatus for receiving an interactive lecture service in correspondence to the apparatus for providing an interactive lecture service as described above will be described. First, the apparatus (student terminal) for receiving media stream switching based interactive lecture service transmits the lecture participation request in the lecture session opened by the lecturer terminal and is approved by the lecturer terminal and thus, is included in the lecture session.

As shown in FIG. 9, an apparatus 900 for receiving an interactive lecture service according to an exemplary embodiment of the present invention may include a right to speak requesting unit 910 that transmits the right to speak request to the lecturer terminal, a transmitting unit 930 that transmits at least one of the question video and voice to the lecturer terminal when the right to speak requesting unit 910 is assigned with the right to speak from the lecturer terminal, and a receiving unit 950 that receives at least one of the question video and voice from the lecturer terminal.

In this configuration, when the lecturer terminal retrieves the right to speak of the right to speak requesting unit 910, the receiving unit 950 may receive at least one of the lecture video and voice from the lecturer terminal.

Here, when the student terminal receives at least one of the video and voice or at least one of the question video and voice of the student terminal from the lecturer terminal, the video and voice may be transmitted in the broadcast scheme or the unicast scheme using the IP transport network.

That is, in the case of using the broadcasting scheme, the student terminal receives the multicast IP and port information of the lecture session when the lecturer terminal opens the lecture session and informs the student terminal of the received information and the student terminals may receive at least one of the lecture video and voice or at least one of the question video and voice via the IP transport network based on the IP and port.

When using the unicast scheme, at least one of the video and voice is directly transmitted between the lecturer terminal and the student terminal without passing through the IP transport network.

According to the method and system for providing an interactive lecture service, it is possible to provide the interactive lecture service capable of performing questions and answers during the online lecture without using the media mixer. That is, in the system for controlling media stream switching based interactive lecture service according to the exemplary embodiment of the present invention, it is possible to control the video or voice streaming of the terminal having a right to speak by switching the media stream in a lecturer terminal.

Therefore, unlike the system for controlling a video conference based interactive lecture service according to the related art, it is possible to provide the interactive lecture service without the media mixer.

What is claimed is:

1. A method for providing a media stream switching based interactive lecture service, comprising:
receiving a right to speak request from at least one student terminal by a lecturer terminal;
assigning a right to speak to a specific student terminal in response to the right to speak request and receiving at least one of a question video and voice of the specific student terminal by the lecturer terminal; and
transmitting at least one of the receiving question video and voice of the specific student terminal to a terminal included in a lecture session by the lecturer terminal.

2. The method of claim 1, further comprising: opening the lecture session and participating at least one student terminal in the lecture session by the lecturer terminal

3. The method of claim 1, further comprising: retrieving the right to speak of the specific student terminal and transmitting at least one of the lecture video and voice of the lecturer terminal to the terminal included in the lecture session by the lecturer terminal.

4. The method of claim 1, wherein the terminal included in the lecture session includes the lecturer terminal and at least one student terminal

5. The method of claim 1, wherein the lecturer terminal transmits at least one of the question video and voice to the terminal included in the lecture session via an IP transport network in a multicast scheme.

6. The method of claim 1, wherein the lecturer terminal transmits at least one of the question video and voice to the terminal included in the lecture session in a unicast scheme.

7. The method of claim 3, wherein the lecturer terminal transmits at least one of the lecture video and voice to the terminal included in the lecture session via an IP transport network in a multicast scheme.

8. The method of claim 3, wherein the lecturer terminal transmits at least one of the lecture video and voice to the terminal included in the lecture session in a unicast scheme.

9. A method for receiving a media stream switching based interactive lecture service, comprising:
transmitting a right to speak request to a lecturer terminal by a student terminal;
assigning a right to speak to the student terminal from the lecturer terminal and transmitting at least one of question video and voice of the student terminal to the lecturer terminal by the student terminal; and
receiving at least one of the question video and voice from the lecturer terminal by the student terminal.

10. The method of claim 9, further comprising: when the lecturer terminal retrieves the right to speak of the student terminal, receiving at least one of the lecture video and voice from the lecturer terminal by the student terminal.

11. An apparatus for providing a media stream switching based interactive lecture service, comprising:
a right to speak control unit that receives a right to speak request from at least one student terminal;
a stream control unit that receives at least one of the question video and voice of the specific student terminal when the right to speak control unit assigns a right to speak to the specific student terminal in response to the right to speak request; and
a stream processing unit that transmits at least one of the question video and voice of the specific student terminal received by the stream control unit to a terminal included in a lecture session.

12. The apparatus of claim 11, further comprising: a session control unit that opens the lecture session and includes at least one student terminal in the lecture session.

13. The apparatus of claim 11, wherein when the right to speak control unit retrieves the right to speak of the specific student terminal, the stream processing unit transmits at least one of the lecture video and voice of the lecturer terminal to the terminal included in the lecture session.

14. The apparatus of claim 11, wherein the terminal included in the lecture session includes the apparatus for providing an interactive lecture service and at least one student terminal.

15. The apparatus of claim 11, wherein the stream processing unit transmits at least one of the question video and voice to the terminal included in the lecture session via an IP transport network in a multicast scheme.

16. The apparatus of claim 11, wherein the stream processing unit transmits at least one of the question video and voice to the terminal included in the lecture session in a unicast scheme.

17. The apparatus of claim 13, wherein the stream processing unit transmits at least one of the lecture video and voice to the terminal included in the lecture session via an IP transport network in a multicast scheme.

18. The apparatus of claim 13, wherein the stream processing unit transmits at least one of the lecture video and voice to the terminal included in the lecture session in a unicast scheme.

19. An apparatus for receiving a media stream switching based interactive lecture service, comprising:
a right to speak requesting unit that transmits a right to speak request to a lecturer terminal;
a transmitting unit that transmits at least one of question video and voice to the lecturer terminal when the right to speak requesting unit is assigned with a right to speak from the lecturer terminal; and
a receiving unit that receives at least one of the question video and voice from the lecturer terminal.

20. The apparatus of claim 19, wherein when the lecturer terminal retrieves the right to speak of the right to speak requesting unit, the receiving unit receives at least one of the lecture video and voice from the lecturer terminal.
